(19) United States
(12) Patent Application Publication
(10) Pub. No.: US 2006/0125711 A1
(43) Pub. Date: Jun. 15, 2006

(54) Adjustable antenna

(76) Inventor: Cheng-Si Wang, Changhua Hsien (TW)

Correspondence Address: HERSHKOVITZ & ASSOCIATES, 1725 I STREET NW, SUITE 300, WASHINGTON, DC, 20006, US

(21) Appl. No.: 11/011,919

(22) Filed: Dec. 15, 2004

(51) Int. Cl. H01Q 3/02

(52) U.S. Cl. 343/882

(57) ABSTRACT

An antenna has a base, a rotating base, a supporting arm, an antenna body and a positioning device. The rotating base is rotatably mounted on the base. The supporting arm is pivotally connected to the rotating base. The antenna body is pivotally attached to the supporting arm. The positioning device is mounted between the supporting arm and the rotating base to support the antenna body at a desired position. Accordingly, the antenna body can be adjusted to a desired angle, direction and height so as to provide an excellent signal-receiving effect.

### BACKGROUND OF THE INVENTION

1. Field of the Invention

The present invention relates to an antenna, and more particularly to an adjustable antenna to provide an excellent signal-receiving effect.

2. Description of Related Art

Indoor television antennas are connected to televisions for receiving television signals transmitted from television stations. To improve the signal-receiving effect, an antenna is always adjustable to try to achieve optimum reception of those signals and so acquire the best TV picture. However, the conventional antenna can only be adjusted at angle or direction but cannot be adjusted in height, such that the conventional antenna is not sufficiently versatile in use and cannot provide an excellent signal-receiving effect.

To overcome the shortcomings, the present invention tends to provide an antenna to mitigate or obviate the aforementioned problems.

### SUMMARY OF THE INVENTION

The main objective of the invention is to provide an antenna that can be adjusted to desired angle, direction and height so as to provide an excellent signal-receiving effect. The antenna has a base, a rotating base, a supporting arm, an antenna body and a positioning device. The rotating base is rotatably mounted on the base. The supporting arm is pivotally connected to the rotating base. The antenna body is pivotally attached to the supporting arm. The positioning device is mounted between the supporting arm and the rotating base to support the antenna body at a desired position.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an adjustable antenna in accordance with the present invention;

FIG. 2 is an exploded perspective view of the antenna in FIG. 1;

FIG. 3 is a side plan view in partial cross section of the antenna in FIG. 1 showing that the antenna body is at a lowest position;

FIG. 4 is a bottom view of the antenna in FIG. 1;

FIG. 5 is an exploded perspective view of the positioning device of the antenna in FIG. 2;

FIG. 6 is an operational bottom view of the antenna in FIG. 1 showing that the antenna body is rotated to adjust the angle of the antenna body relative to the base; and

FIG. 7 is a side plan view of the antenna in FIG. 1 showing that the antenna body is adjusted to a highest position.

### DETAILED DESCRIPTION OF PREFERRED EMBODIMENT

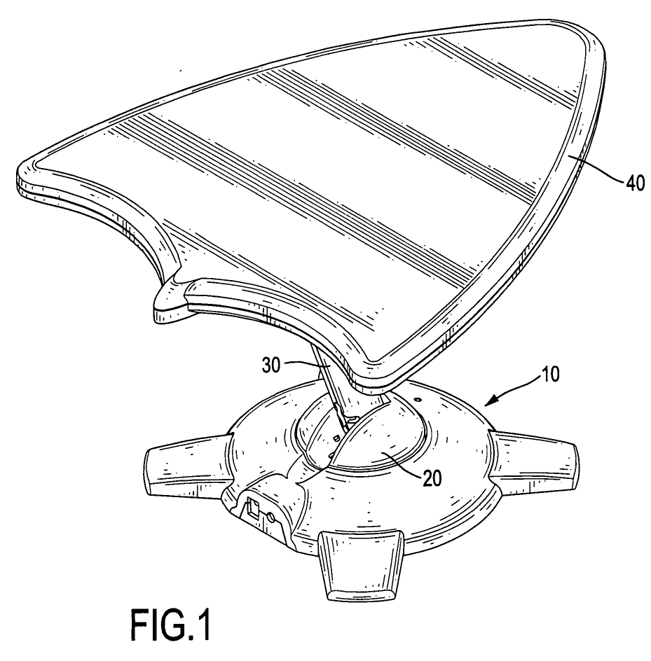

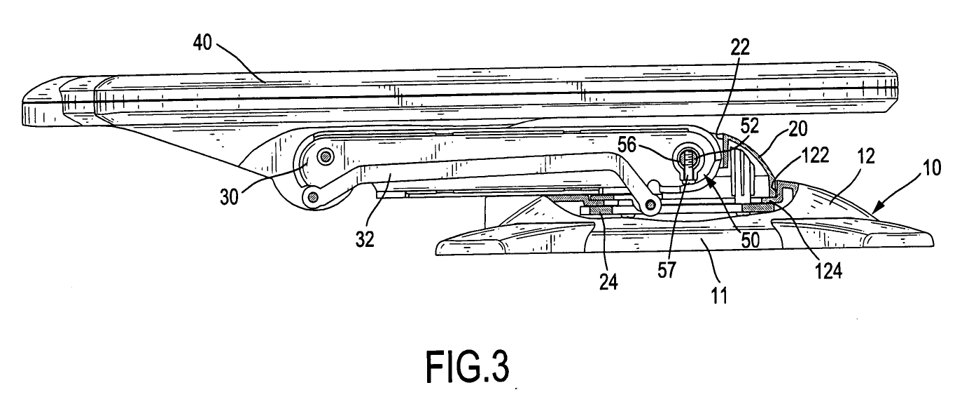

With reference to FIG. 1 to 4, an antenna in accordance with the present invention comprises a base (10), a rotating base (20), a supporting arm (30), an antenna body (40) and a positioning device (50).

The base (10) is composed of a bottom plate (11) and a top cover (12) attached to the bottom plate (11). The top cover (12) has an opening (122) with an inner surface defined in the top of the top cover (12). A shoulder (124) is formed on the inner surface of the opening (122).

The rotating base (20) is rotatably mounted on the base (10). In the preferred embodiment, the rotating base (20) is rotatably mounted inside the opening (122) in the top cover (12) and is supported on the shoulder (124) in the opening (122). The rotating base (20) has a recess (22) defined in the top of the rotating base (20).

In addition, an annular collar (24) is securely attached to the rotating base (20) to rotate with the rotating base (20) and abuts against the bottom of the shoulder (124) in the opening (22) to abut the shoulder (124) in cooperation with the rotating base (20). The top cover (12) has a protrusion (126) formed on the bottom of the top cover (12). The collar (24) has a tab (242) corresponding to and selectively abutting against the protrusion (126) on the top cover (12). With the abutment between the protrusion (124) on the top cover (12) and the tab (242) on the collar (24), the rotation of the rotating base (20) is limited. Consequently, the rotating base (20) can be kept from rotating beyond 360 degrees, such that wires extending through the rotating base (20) from the base (10) to the antenna body (40) can be kept from becoming twisted and stretched.

The supporting arm (30) is pivotally connected to the rotating base (20). In the preferred embodiment, the supporting arm (30) is pivotally mounted in the recess (22). The supporting arm (30) can be hollow, and a connecting arm (32) is mounted inside the supporting arm (30) and has two ends.

The antenna body (40) is pivotally attached to a top end of the supporting arm (30) to receive appropriate signals. The ends of the connecting arm (32) are pivotally connected respectively to the rotating base (20) and the antenna body (40) to provide a further supporting effect to the antenna body (40).

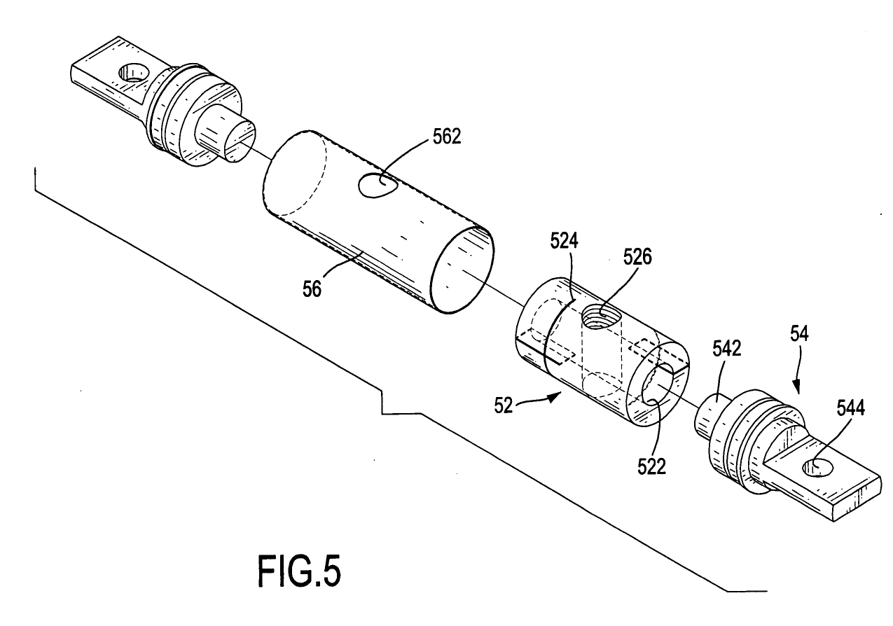

The positioning device (50) is mounted between the supporting arrn (30) and the rotating base (20) to support the antenna body (40) at a desired position. With further reference to FIG. 5, the positioning device (50) comprises an axle (52), two connecting rods (54) and an outer sleeve (56). The axle (52) is securely attached to the supporting arm (30) and has two holes (522), two slits (524) and a threaded hole (526). The holes (522) are defined respectively in two ends of the axle (52). The slits (524) are defined respectively at the ends of the axle (52) and communicate respectively with the holes (522). The threaded hole (526) is laterally defined through the axle (52).

The connecting rods (54) are inserted respectively into the holes (522) in the axle (52) and are securely connected to the rotating base (20). Each connecting rod (54) has a cylindrical stub (542) rotatably mounted inside a corresponding one of the holes (522) in the axle (52) to rotatably attach the connecting rod (54) to the axle (52). The cylindrical stub (542) has a diameter larger than an inner diameter of the corresponding hole (522). Consequently, the holes (522) in the axle (52) will be expanded when the cylindrical stubs (542) are inserted into the holes (522). With the arrangement of the slits (524), the stubs (542) are tightly engaged in the holes (522) in the axle (52) with compression forces provided by peripheries defining the holes (522) to keep the connecting rods (54) from disengaging from the axle (52).

The outer sleeve (56) is mounted around the axle (52) to provide a limiting effect to the slits (524) in the axle (52), such that the compression force provided by the peripheries of the holes (522) and applied to the cylindrical stubs (542) is enhanced. A bore (562) is defined in the outer sleeve (56) and is aligned with the threaded hole (526) in the axle (52). A bolt (57) extends into the supporting arm (30) and through the bore (562) in the outer sleeve (56) and screws into the threaded hole (526) in the axle (52). With the bolt (57), the axle (52) of the positioning device (50) is securely connected with and rotated with the supporting arm (30).

In addition, two brackets (58) are securely attached to the rotating base (20) and are securely connected respectively with the connecting rods (54). Each bracket (58) has a through hole (582), and each connecting rod (54) has a through hole (544) aligning with the through hole (582) in a corresponding one of the brackets (58). A plurality of screws (59) extends through the through holes (544,582) in the corresponding connecting rod (54) and bracket (58) and are screwed into the rotating base (20) to securely connect the connecting rod (54) and bracket (58) together.

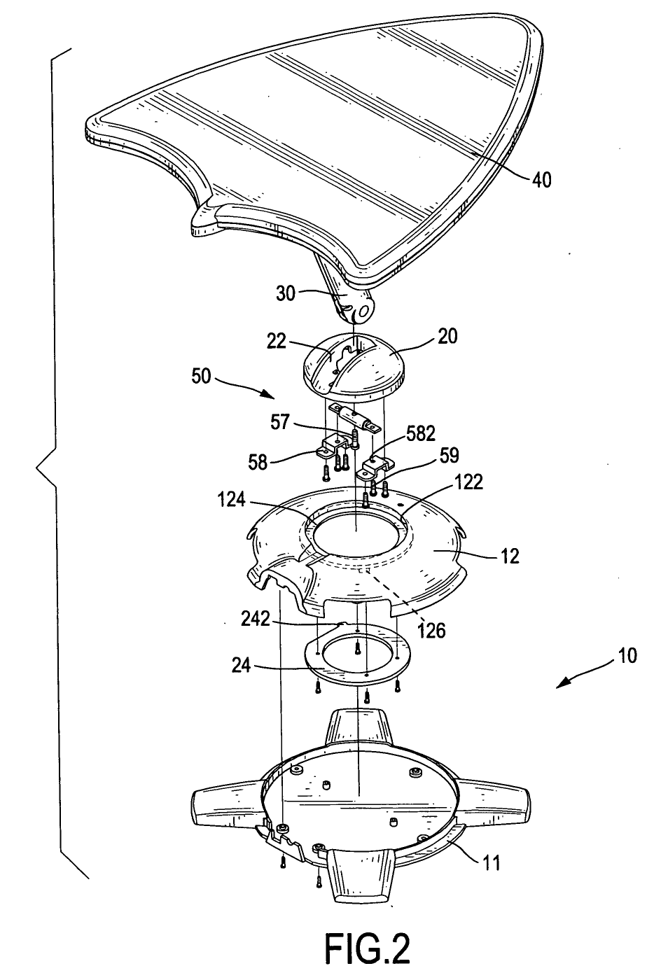

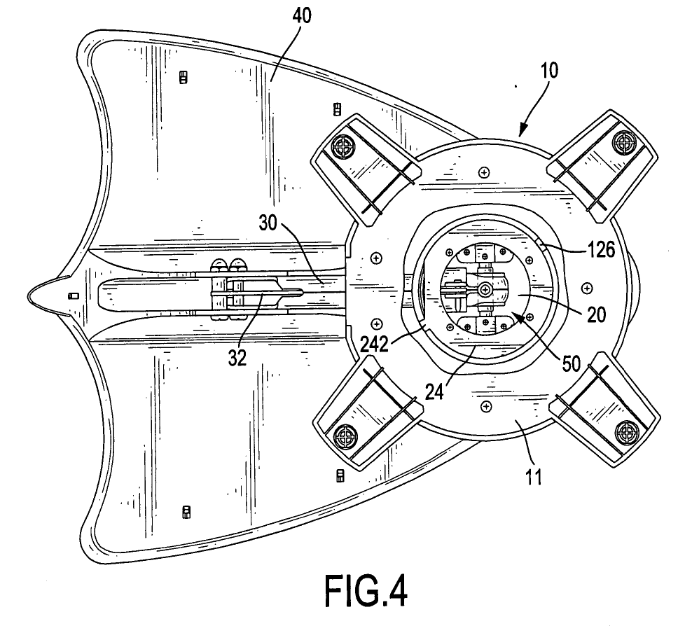

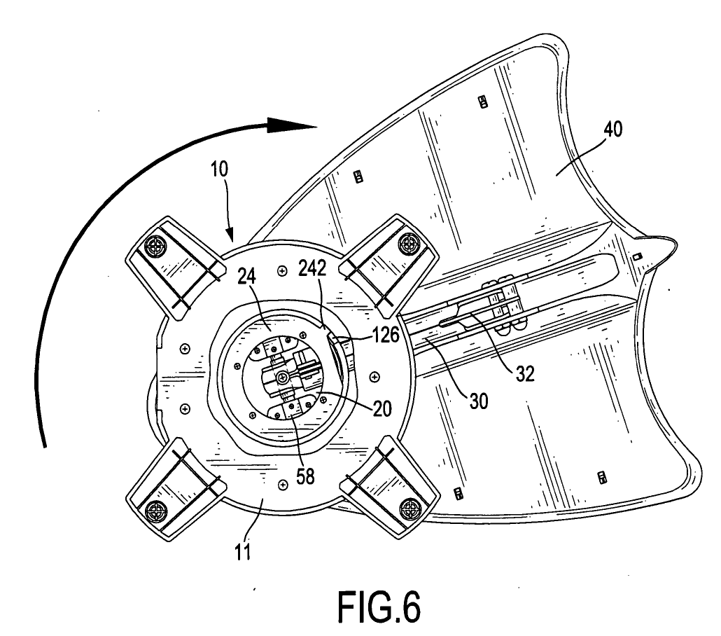

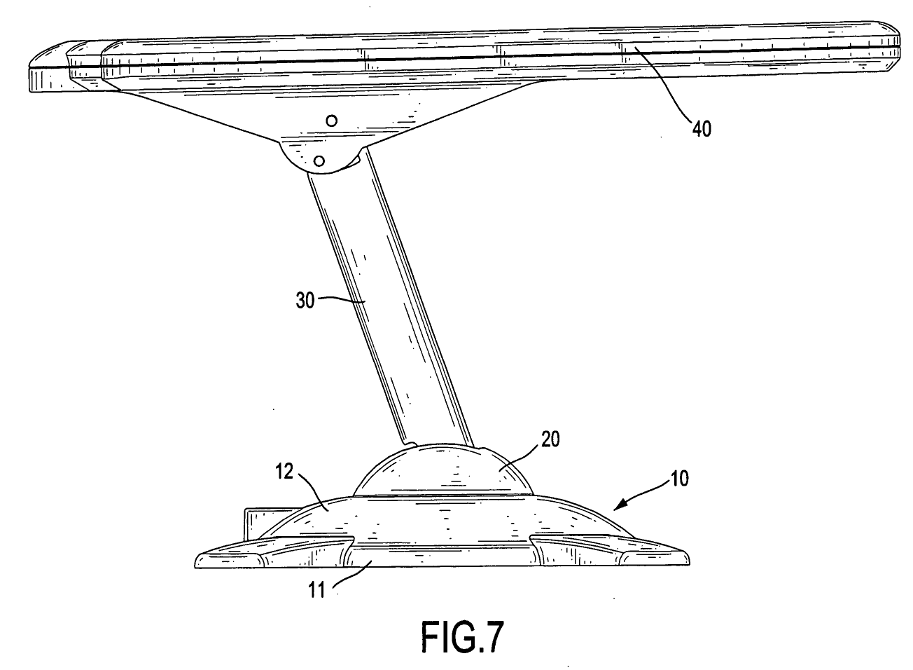

With reference to FIGS. 4 and 6, with the rotation of the rotating base (20) relative to the base (10), the angle and the direction of the antenna body (40) can be changed. With reference to FIGS. 2, 3, 5 and 7, when the antenna body (40) is lifted, the supporting arm (30) will pivotally rotate relative to the rotating base (20). The axle (52) of the positioning device (50) will rotate with the supporting arm (30) and relative to the connecting rods (54) that are securely connected to the rotating base (20). With the compression force provided by the peripheries defining the holes (522) in the axle (52) and applied to the stubs (542) on the connecting rods (52), the rotation between the axle (52) and the connecting rods (54) is prevented. Accordingly, the supporting arm (30) can be kept from rotation when the user releases the antenna body (40). Thus, the antenna body (40) can be positioned at any desired height, such that the antenna body (40) can be adjusted in angle, direction and height so as to provide an excellent signal-receiving effect.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An antenna comprising:
a base;
a rotating base rotatably mounted on the base;
a supporting arm pivotally connected to the rotating base;
an antenna body pivotally attached to the supporting arm; and
a positioning device mounted between the supporting arm and the rotating base to support the antenna body at a desired position.

2. The antenna as claimed in claim 1, wherein the positioning device comprises:
an axle securely attached to the supporting arm and having
two holes defined respectively in two ends of the axle; and
two slits defined respectively at the ends of the axle and communicating respectively with the holes;
two connecting rods attached respectively into the holes in the axle and securely connected to the rotating base, and each connecting rod having a cylindrical stub rotatably mounted inside a corresponding hole, wherein the cylindrical stub has a diameter larger than an inner diameter of the corresponding hole.

3. The antenna as claimed in claim 2, wherein the positioning device further comprises an outer sleeve mounted around the axle.

4. The antenna as claimed in claim 3, wherein
the axle has a threaded hole laterally defined through the axle;
a bore is defined in the outer sleeve and aligned with the threaded hole in the axle; and
a bolt extends into the supporting arm and through the bore in the outer sleeve and screws into the threaded hole in the axle.

5. The antenna as claimed in claim 4 further comprising two brackets securely attached to the rotating base and securely connected respectively with the connecting rods,
wherein each bracket has a through hole;
each connecting rod has a through hole aligning with the through hole in a corresponding bracket; and
a screw extends through the through holes in the corresponding connecting rod and bracket and screws into the rotating base.

6. The antenna as claimed in claim 5, wherein
the base comprises a bottom plate and a top cover attached to the bottom plate;
the top cover has an opening with an inner surface to rotatably hold the rotating base; and
the opening has a shoulder formed on the inner surface to support the rotating base.

7. The antenna as claimed in claim 6 further comprising an annular collar securely attached to the rotating base and abutting against a bottom of the shoulder in the opening to abut the shoulder in cooperation with the rotating base.

8. The antenna as claimed in claim 7, wherein the top cover has a protrusion formed on a bottom of the top cover; and
the collar has a tab corresponding to and selectively abutting against the protrusion on the top cover.

9. The antenna as claimed in claim 8, wherein the rotating base has a recess and the supporting arm is pivotally mounted in the recess with the axle of the positioning device.

10. The antenna as claimed in claim 9, wherein the supporting arm is hollow; and
a connecting arm is mounted inside the supporting arm and has two ends pivotally connected respectively to the rotating base and the antenna body.

11. The antenna as claimed in claim 2 further comprising two brackets securely attached to the rotating base and securely connected respectively with the connecting rods,
wherein each bracket has a through hole;
each connecting rod has a through hole aligning with the through hole in a corresponding bracket; and
a screw extends through the through holes in the corresponding connecting rod and bracket and screws into the rotating base.

12. The antenna as claimed in claim 1, wherein
the base comprises a bottom plate and a top cover attached to the bottom plate;
the top cover has an opening with an inner surface to rotatably hold the rotating base; and
the opening has a shoulder formed on the inner surface to support the rotating base.

13. The antenna as claimed in claim 12 further comprising an annular collar securely attached to the rotating base and abutting against a bottom of the shoulder in the opening to abut the shoulder in cooperation with the rotating base.

14. The antenna as claimed in claim 13, wherein the top cover has a protrusion formed on a bottom of the top cover; and
the collar has a tab corresponding to and selectively abutting against the protrusion on the top cover.

15. The antenna as claimed in claim 1, wherein the rotating base has a recess and the supporting arm is pivotally mounted in the recess with the positioning device.

16. The antenna as claimed in claim 15, wherein the supporting arm is hollow; and
a connecting arm is mounted inside the supporting arm and has two ends pivotally connected respectively to the rotating base and the antenna body.

17. The antenna as claimed in claim 11, wherein the supporting arm is hollow; and
a connecting arm is mounted inside the supporting arm and has two ends pivotally connected respectively to the rotating base and the antenna body.
